(19) United States
(12) Patent Application Publication
(10) Pub. No.: US 2020/0382291 A1
(43) Pub. Date: Dec. 3, 2020

(54) VERIFICATION DEVICE, COMPUTER READABLE MEDIUM, AND VERIFICATION METHOD

(71) Applicant: Mitsubishi Electric Corporation, Tokyo (JP)

(72) Inventors: Hiroyuki SAKAKIBARA, Tokyo (JP); Kiyoto KAWAUCHI, Tokyo (JP); Tomonori NEGI, Tokyo (JP)

(73) Assignee: Mitsubishi Electric Corporation, Tokyo (JP)

(21) Appl. No.: 16/636,554

(22) PCT Filed: Sep. 15, 2017
(86) PCT No.: PCT/JP2017/033479

§ 371 Date: Feb. 4, 2020

(51) Int. Cl. H04L 9/08; H04L 9/32

(52) U.S. Cl. CPC H04L 9/0825; H04L 9/3247; H04L 9/3268

(57) ABSTRACT

An acquisition unit acquires reception data. A first extraction unit extracts a domain name being a download domain name from the reception data. A second extraction unit extracts owner information indicating an owner of a public key certificate included in the reception data. A search unit searches a domain information search service using the owner information as a search key, and acquires a management domain name managed by the owner indicated by the owner information. A determination unit collates the management domain name with the domain name to determine whether a program included in the reception data is illegitimate.

### TECHNICAL FIELD

The present invention relates to a verification device, a verification program, and a verification method which verify whether a program with a code signature is authentic.

### BACKGROUND ART

When malware acts on an OS (Operating System), the malware takes the form of a driver, for example. Hereinafter, a driver will be described as an example. Recent OSs require an official code signature from the driver. However, today's malware used for a cyber attack is sometimes attached with a genuine code signature based on stolen “code signature key and public key certificate”. No means is available for detecting that the code signature corresponds to this stolen case. As a consequence, the user will install a program disguised as a driver, and the terminal will be infected with malware. Supposedly, the attacker steals a code signature key and a public key certificate from an enterprise or organization in advance by a cyber attack, signs the malware, and exploits the signed malware for another cyber attack.

A code signature key which is a private key should be operated securely by the genuine owner. Dedicated hardware (HSM: Hardware Security Module) is available that securely stores the code signature key and attaches a signature to inputted data. As the code signature key cannot be extracted from the HSM to the outside, it is impossible to extract the code signature key by a cyber attack. However, sometimes the HSM is not utilized because purchase and maintenance costs are required to operate the HSM. In that case, the code signature key and the public key certificate are probably kept on the OS and managed as files.

Many cyber attack reports describe cases where a file storing a key and a public key certificate and having an extension “.p12” is searched for. This indicates that the attacker is aiming at the key and the public key certificate which are stored as a file on the OS. In this case, although the key and the public key certificate are not necessarily a key and a public key certificate for code signature, the attacker is probably targeting data for code signature as well.

As a theft prevention of a code signature key and a public key certificate, a method may be possible that detects a theft by finding a suspicious process of searching for a file with the extension “p12” from the event log. However, this method is a countermeasure taken by the owner of the code signature key and public key certificate. There is no guarantee that the owner surely practices this method as a countermeasure, as with the HSM. Therefore, what is needed as a countermeasure against infection with code-signed malware is a checking function on the recipient side of the code-signed malware.

A conventional technique is available that checks validity of a public key certificate used for verifying the authenticity of a code signature and paired with a code signature key (for example, Non-Patent Literature 1 and Non-Patent Literature 2).

### CITATION LIST

### Non-Patent Literature

Non-Patent Literature 1: Certificate Revocation List (CRL), IETF RFC 5280, Internet X. 509 Public Key Infrastructure Certificate and Certificate Revocation List (CRL) Profile.
Non-Patent Literature 2: Online Certificate Status Protocol (OCSP), IFTF RFC2560, X. 509 Internet Public Key Infrastructure Online Certificate Status Protocol-OCSP.

A CRL (Certificate Revocation List) is a revocation list describing information on revoked public key certificates. An OCSP is a protocol for inquiring the revocation status of public key certificates online. However, with the CRL and the OCSP, only “a public key certificate” that is revoked can be judged invalid. Since revocation is constituted by a declaration from a third party or the owner, a declaration does not arise unless someone or the owner notices a theft. It is also unlikely that an attacker declares a revocation. Therefore, these techniques are not effective as a countermeasure against code-signed malware.

Thus, the prior art cannot prevent illegitimate installation of code-signed malware that is based on a code signature key and a public key certificate which are stolen by an attacker.

### SUMMARY OF INVENTION

### Technical Problem

It is an objective of the present invention is to provide a verification device capable of detecting a program attached with an illegitimate code signature that is based on “a code signature key and a public key certificate” stolen by an attacker.

### Solution to Problem

A verification device according to the present invention includes:

an acquisition unit to acquire reception data including a public key certificate, a program, and a digital signature, the public key certificate including a public key, the digital signature being attached to the program;

a first extraction unit to extract, from the reception data, a download domain name indicating a domain name of a sender of the reception data;

a second extraction unit to extract, from the public key certificate included in the reception data, owner information indicating an owner of the public key certificate;

a search unit to acquire a management domain name managed by the owner indicated by the owner information from a domain information search service by searching the domain information search service using the owner information as a search key; and

a determination unit to collate the management domain name acquired by the search unit with the download domain name extracted by the first extraction unit and to determine whether or not the program included in the reception data is illegitimate based on a collation result.

### Advantageous Effects of Invention

A verification device of the present invention includes a determination unit which collates a management domain name acquired by a search unit with a download domain name extracted by a first extraction unit and determines whether or not a program included in reception data is illegitimate based on a collation result. Therefore, according to the verification device of the present invention, it is possible to detect a program attached with an illegitimate code signature that is based on a code signature key and a public key certificate which are stolen by an attacker.

### BRIEF DESCRIPTION OF DRAWINGS

FIG. 1 representing Embodiment 1 is a diagram illustrating an operation form of a verification device 1.

FIG. 2 representing Embodiment 1 is a functional configuration diagram of the verification device 1.

FIG. 3 representing Embodiment 1 is a hardware configuration diagram of the verification device 1.

FIG. 4 representing Embodiment 1 is a flowchart indicating an outline of behavior of the verification device 1.

FIG. 5 representing Embodiment 1 is a flowchart indicating processes of an analysis unit 12 and domain name extraction unit 17.

FIG. 6 representing Embodiment 1 is a flowchart indicating a process of extracting program information 105 from a content 104b by a program information extraction unit 13.

FIG. 7 representing Embodiment 1 is a diagram illustrating the program information 105.

FIG. 8 representing Embodiment 1 is a flowchart indicating a process of extracting a certificate 105d from the program information 105 by a certificate extraction unit 14.

FIG. 9 representing Embodiment 1 is a flowchart indicating a process of checking a domain name by a determination unit 18.

FIG. 10 representing Embodiment 1 is a diagram illustrating a modification of the verification device 1.

FIG. 11 representing Embodiment 2 is a functional configuration diagram of a verification device 1.

FIG. 12 representing Embodiment 2 is a flowchart indicating a process of checking an owner of a certificate by a determination unit 18.

FIG. 13 representing Embodiment 3 is a flowchart indicating a process performed by a certificate extraction unit 14.

### DESCRIPTION OF EMBODIMENTS

Embodiments of the present invention will be described below with referring to drawings. In the drawings, the same or equivalent portions are denoted by the same reference numerals. In describing the embodiments, explanation on the same or equivalent portions will be omitted or simplified appropriately.

### Embodiment 1

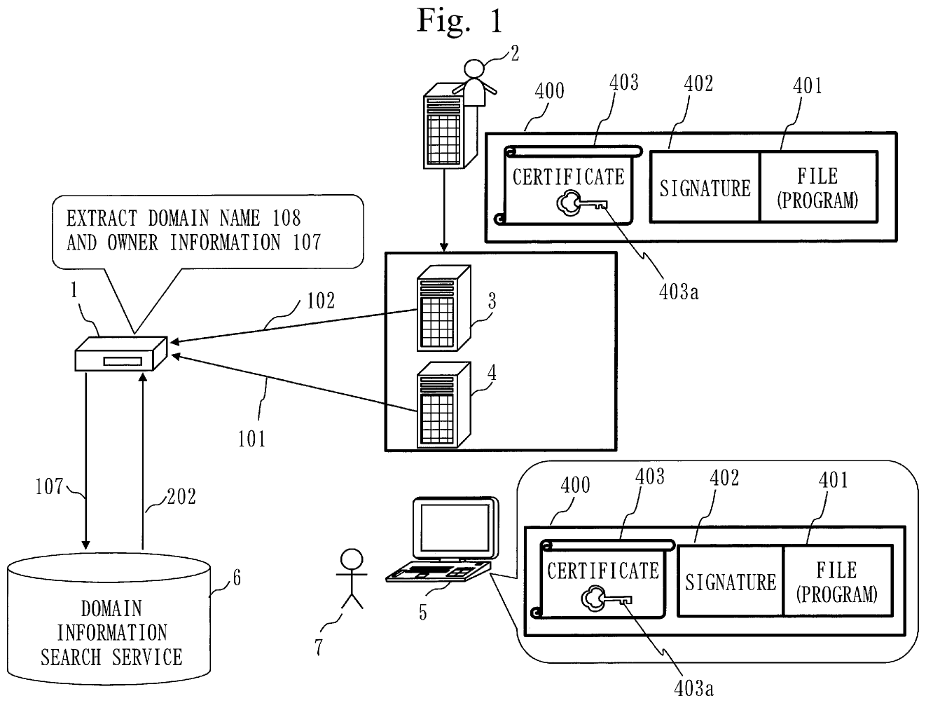

A code signature verification device 1 according to Embodiment 1 will be described with referring to FIGS. 1 to 10. The code signature verification device 1 is a device that verifies whether or not a code-signed program is authentic. The code signature verification device 1 will be referred to as verification device 1 hereinafter.

The verification device 1 acquires program information including: a public key certificate including a public key; a program; and a signature to the program. The verification device 1 verifies whether the program is authentic. The public key certificate will be referred to as certificate hereinafter.

FIG. 1 is a diagram illustrating an operation form of the verification device 1. The operation form of the verification device 1 will be described with referring to FIG. 1. An attacker 2 places a code-signed illegitimate program on a website.

The code-signed illegitimate program will be referred to as illegitimate-program information 400 hereinafter. As illustrated in FIG. 1, the illegitimate-program information 400 is formed of the following (a), (b), and (c).

(a) a main body of an illegitimate program expressed as file 401 in FIG. 1

(b) a code signature expressed as signature 402 in FIG. 1

(c) a certificate 403 including a public key 403a and verifying legitimacy of the code signature

A user 7 who uses a terminal device 5 (to be referred to as terminal 5 hereinafter) accesses an URL (Uniform Resource Locator) written on an email disguising a program support and sent from the attacker 2. Note that this URL is the URL of a website where the illegitimate-program information 400 is placed. Alternatively, this website disguises a program download site. Then, when the user 7 performs a search using a search service, this website is presented, and the user 7 accidentally accesses this website. As a result, the illegitimate-program information 400 reaches the terminal 5.

Alternatively, there is a case where the attacker 2 disguises a program support and sends the illegitimate-program information 400 to the user 7 by an email with an attachment. As a result, the illegitimate-program information 400 reaches the terminal 5. Namely, the illegitimate-program information 400 is distributed to the user 7 by two routes: downloading from a website; and transmission of an email with an attachment. The illegitimate-program information 400 reaches the terminal 5 consequently. When installing the illegitimate-program information 400, a warning against a code signature is not displayed on the terminal 5, so the user 7 installs the file 401 without suspicion. Consequently, the terminal 5 is infected with the file 401 being malware. The terminal 5 is infected with the illegitimate-program information 400 in this manner.

An outline of behavior of the verification device 1 will be described with referring to FIG. 1.

(1) The verification device 1 receives a packet received by an email server 3 or proxy server 4 owned by the organization.

In the case of the email server 3, reception of an email for the user 7 corresponds to reception of a packet. In the case of the proxy server 4, reception of a web content corresponds to reception of a packet. A packet being data 102 from the email server 3 contains the illegitimate-program information 400 being included in an attachment to the email. A packet being data 101 from the proxy server 4 contains the illegitimate-program information 400 being included in a downloaded web content.

(2) The verification device 1 extracts, from the packets, a download domain name 108 (to be referred to as domain name 108 hereinafter) of a domain that is the sender of the illegitimate-program information 400. The verification device 1 extracts, from the packets, the illegitimate-program information 400 and furthermore the certificate 403.

(3) The verification device 1 extracts owner information 107 included in the certificate 403 to indicate the owner of the certificate 403.

(4) Using the owner information 107 as a search key, the verification device 1 performs a search by a domain information search service 6 (to be described later) and acquires a management domain name 202.

(5) The verification device 1 verifies whether the acquired management domain name 202 includes the extracted domain name 108 to determine whether or not the signed program is authentic.

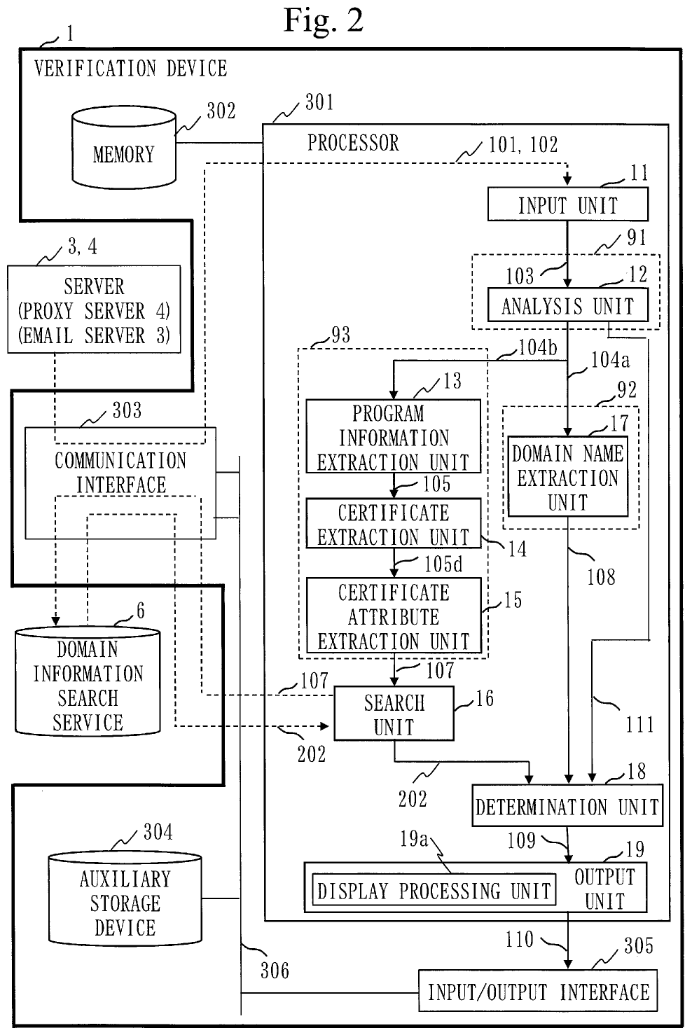

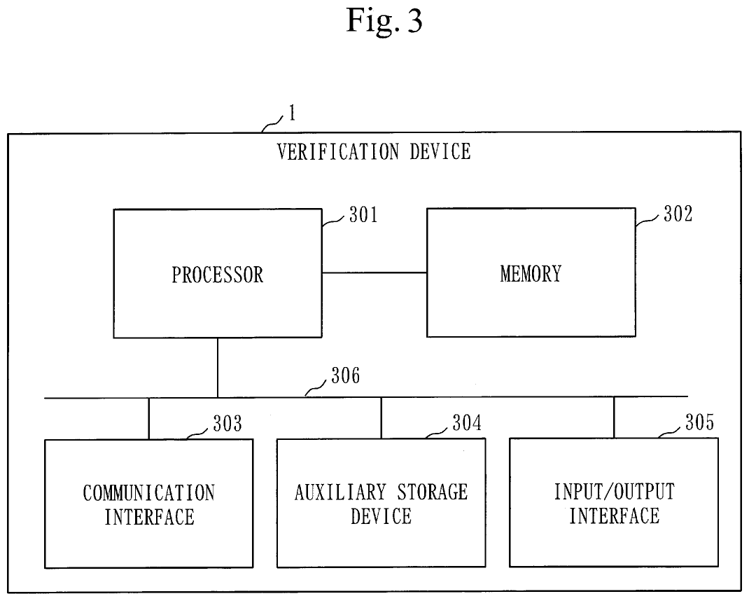

A configuration of the verification device 1 will be described with referring to FIGS. 2 and 3.

FIG. 2 is a functional configuration diagram of the verification device 1 of Embodiment 1.

FIG. 3 is a hardware configuration diagram of the verification device 1 according to Embodiment 1.

The verification device 1 is a computer. The verification device 1 is provided with a processor 301 as well as other hardware devices such as a memory 302, a communication interface 303, an auxiliary storage device 304, and an input/output interface 305. The processor 301 is connected to the other hardware devices via a signal line 306 and controls these other hardware devices.

The verification device 1 is provided with an input unit 11, an analysis unit 12, a program information extraction unit 13, a certificate extraction unit 14, a certificate attribute extraction unit 15, a search unit 16, a domain name extraction unit 17, a determination unit 18, and an output unit 19, as function elements. Functions of the input unit 11, analysis unit 12, program information extraction unit 13, certificate extraction unit 14, certificate attribute extraction unit 15, search unit 16, domain name extraction unit 17, determination unit 18, and output unit 19 are implemented by software.

The processor 301 is a device that executes a verification program. The verification program is a program that implements the functions of the input unit 11, analysis unit 12, program information extraction unit 13, certificate extraction unit 14, certificate attribute extraction unit 15, search unit 16, domain name extraction unit 17, determination unit 18, and output unit 19. The processor 301 is an IC (Integrated Circuit) that performs arithmetic processing. Specific examples of the processor 301 include a CPU (Central Processing Unit), a DSP (Digital Signal Processor), and a GPU (Graphics Processing Unit).

The memory 302 is a storage device that stores data temporarily. Specific examples of the memory 302 include an SRAM (Static Random Access Memory) and a DRAM (Dynamic Random Access Memory). The memory 302 keeps an arithmetic processing result of the processor 301.

The communication interface 303 receives communication packet data from a server such as the email server 3 and the proxy server 4. The communication interface 303 may be a port connected to a LAN (Local Area Network).

The auxiliary storage device 304 is a storage device that stores data. Specific examples of the auxiliary storage device 304 include an HDD (Hard Disk Drive). Alternatively, the auxiliary storage device 304 may be a portable storage medium such as an SD (registered trademark; Secure Digital) memory card, a CF (Compact Flash), a NAND flash, a flexible disk, an optical disk, a compact disk, a blu-ray (registered trademark) disk, and a DVD (Digital Versatile Disk).

The input/output interface 305 is connected to a device to input/output data and a result. Examples of the device to input/output the data and result include a mouse, a keyboard, and a display.

The verification program is read by the processor 301 and executed by the processor 301. The memory 302 stores not only the verification program but also an OS (Operating System). The processor 301 executes the verification program while executing the OS. The verification program and the OS may be stored in the auxiliary storage device 304. The verification program and OS stored in the auxiliary storage device 304 are loaded by the memory 302 and executed by the processor 301. The verification program may be incorporated in the OS partly or entirely.

The verification device 1 may be provided with a plurality of processors that replace the processor 301. The plurality of processors share execution of the verification program. Each processor is a device that executes the verification program, as the processor 301 does.

Data, information, a signal value, and a variable value which are utilized, processed, or outputted by the verification program are stored in the memory 302, the auxiliary storage device 304, or a register or cache memory in the processor 301.

The verification program is a program that causes the computer to execute each process, each procedure, or each stage corresponding to the input unit 11, analysis unit 12, program information extraction unit 13, certificate extraction unit 14, certificate attribute extraction unit 15, search unit 16, domain name extraction unit 17, determination unit 18, or output unit 19 with its “unit” being replaced by “process”, “procedure”, or “stage”. A verification method is a method that the verification device 1 being the computer carries out by executing the verification program. The verification program may be recorded in a computer-readable storage medium and provided in the form of the medium, or may be provided in the form of a program product.

***Description on Behavior***

The behavior of the verification device 1 will be described with referring to FIG. 2 and FIGS. 4 to 9.

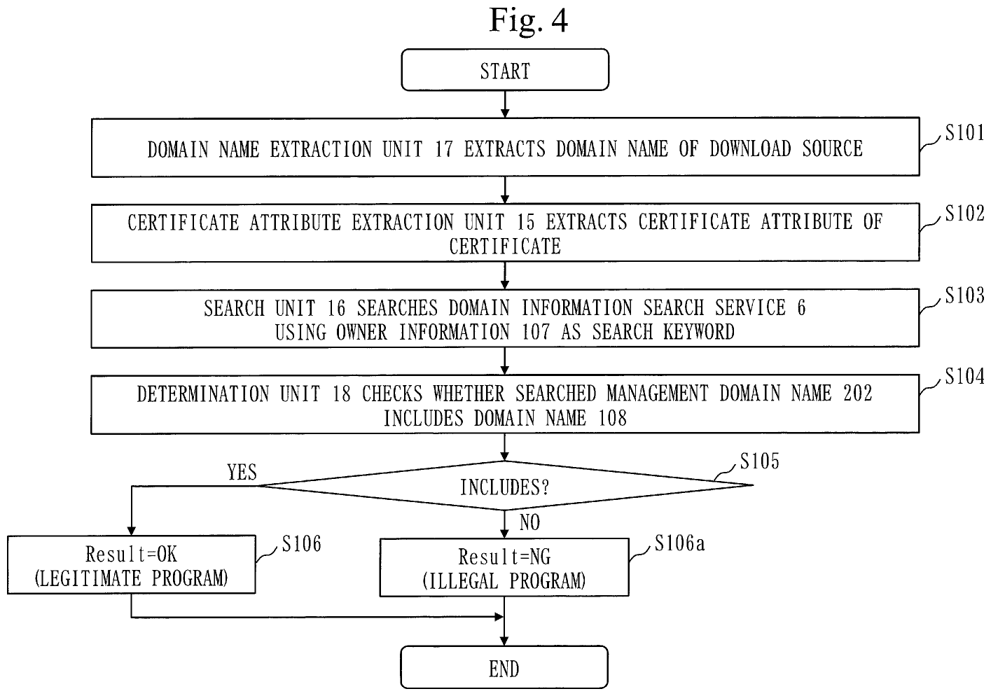

FIG. 4 is a flowchart illustrating an outline of the behavior of the verification device 1. As illustrated in FIG. 2, the input unit 11 receives the data 101 coming from the proxy server 4 and the data 102 coming from the email server 3, from the network via the communication interface 303. The input unit 11 outputs the received data 101 and 102 to the analysis unit 12 as reception data 103.

The analysis unit 12 receives the reception data 103. The analysis unit 12 is an acquisition unit 91. The reception data 103 includes: the public key certificate including the public key; the program; and a digital signature attached to this program. The acquisition unit 91 acquires the reception data 103.

The analysis unit 12 extracts the reception data 103 through separating it into a header 104a and a content 104b according to the format of the email or the format of the web communication data. A standard format is generally employed as the format for transmission/reception by an email or by web communication. Therefore, an extraction process of separation into the header 104a and the content 104b is possible. Then, the analysis unit 12 outputs the content 104b to the program information extraction unit 13 and the header 104a to the domain name extraction unit 17.

The domain name extraction unit 17 is a first extraction unit 92. The first extraction unit 92 extracts, from the reception data 103, the domain name 108 being a download domain name expressing the domain name of the sender of the reception data 103. This will be specifically described as follows.

The domain name extraction unit 17 extracts, from the header 104a, information on a download source of the reception data 103. If a file is downloaded from a website, the domain name extraction unit 17 can extract the domain name of the website from Host in the HTTP (HyperText Transfer Protocol) header. If an email with an attachment is received, the domain name extraction unit 17 can extract a domain name from a portion following @ of the sender's email address. As indicated by step S101 of FIG. 4, the domain name extraction unit 17 extracts the domain name of the transmission source of the reception data 103. The domain name extraction unit 17 outputs the extracted domain name to the determination unit 18 as the domain name 108.

<Behaviors of Analysis Unit 12 and Domain Name Extraction Unit 17>

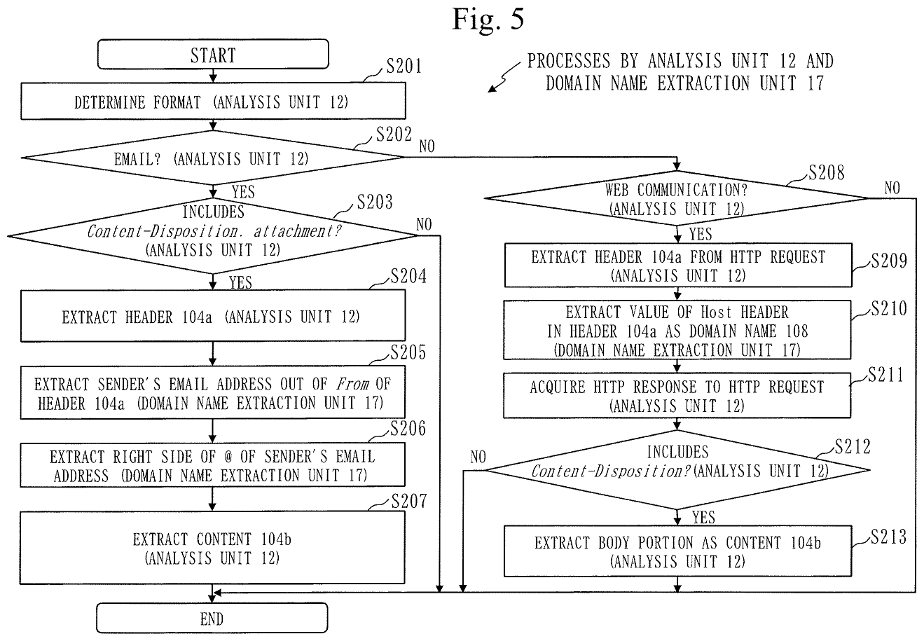

FIG. 5 is a flowchart indicating processes of the analysis unit 12 and domain name extraction unit 17. The processes of the analysis unit 12 and domain name extraction unit 17 will be described with referring to FIG. 5. The parenthesized analysis unit 12 and domain name extraction unit 17 indicate that they are the behavior subjects.

In step S201, the analysis unit 12 determines the format of the reception data 103. In this process, the analysis unit 12 determines the reception data 103 as an email if it is data coming from the email server 102, and as web communication by HTTP if it is data coming from the proxy server.

In step S202, the analysis unit 12 determines whether the reception data 103 is an email.

In step S203, the analysis unit 12 checks whether the reception data 103 includes Content-Disposition: attachment. If the reception data 103 includes Content-Disposition: attachment, the analysis unit 12 extracts a header from the reception data 103.

In step S204, regarding this extraction, the analysis unit 12 extracts a portion starting from the beginning of the data until two dashes “--”. The analysis unit 12 treats this extraction result as the header 104a.

In step S205, the domain name extraction unit 17 extracts the sender's email address out of From of the header 104a.

In step S206, the domain name extraction unit 17 extracts the right side of @ of the sender's email address. The extracted portion is treated as the domain name 108.

In step S207, the analysis unit 12 extracts a portion starting from a line that follows a blank line following Content-Disposition: attachment until data immediately before a blank line which is immediately before two dashes “- -”, as the content 104b.

In step S208, if the reception data 103 is not an email, the analysis unit 12 determines whether the reception data 103 is a web communication. If the reception data 103 is not a web communication, the process ends.

In step S209, the analysis unit 12 extracts an HTTP request, and extracts a portion starting from the beginning until a first blank line of the HTTP request, as the header 104a.

In step S210, the domain name extraction unit 17 extracts a value of a Host header in the header 104a and treats the extracted value as the domain name 108.

In step S211, the analysis unit 12 monitors data coming from the proxy server 4 and extracts an HTTP response to the HTTP request.

In step S212, the analysis unit 12 checks whether the HTTP response includes Content-Disposition.

In step S213, if the HTTP response includes Content-Disposition, the analysis unit 12 extracts a body portion that follows a blank line in the response. The analysis unit 12 treats an extraction result as the content 104b.

When the process of step S207 or step S213 is performed, the domain name 108 is extracted in the course of the process.

The program information extraction unit 13 extracts the code-signed data from the content 104b. The code-signed data has the same structure as that of the illegitimate-program information 400, as will be described later. The code-signed data is sometimes expressed as program information 105, as will be described later. If acquired by an email, the code-signed data corresponds to an attachment. If acquired by a web communication, the code-signed data corresponds to a downloaded file. In this process as well, the standard format is employed as the file format. Therefore, an extraction process is possible. An example of the standard format is CMS (Cryptgraphic Message Syntax) of RFC3852.

A method of extracting code-signed data in a case where the data is an email and a method of extracting code-signed data in a case where the data is a web communication, each of which will be described below, are merely examples. Therefore, none of the extraction method in the case of email and the extraction method in the case of web communication is limited to the method to be described below.

The program information extraction unit 13, the certificate extraction unit 14, and the certificate attribute extraction unit 15 constitute a second extraction unit 93. The second extraction unit 93 extracts the owner information 107 indicating the owner of the certificate from the certificate included in the reception data 103. This will be specifically described below.

<Behavior of Program Information Extraction Unit 13>

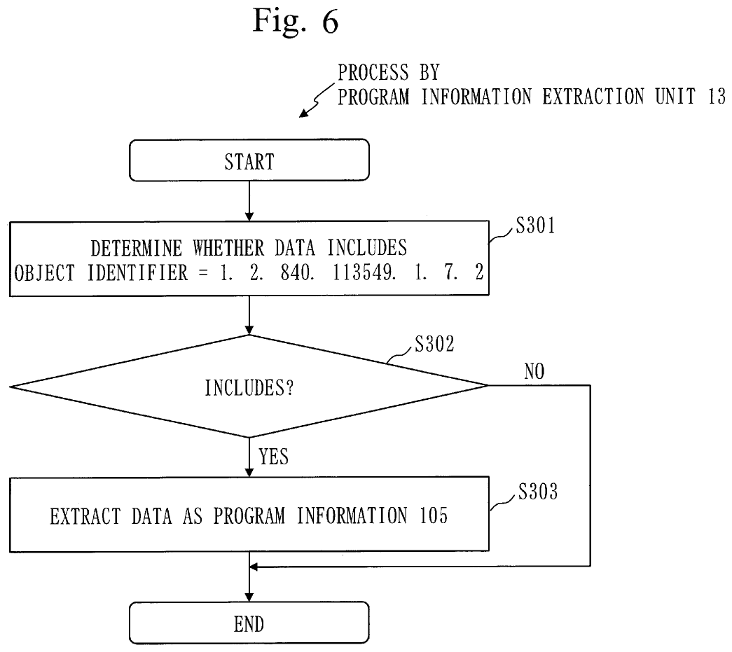

FIG. 6 is a flowchart indicating a process of extracting the code-signed data from the content 104b by the program information extraction unit 13. The code-signed data is sometimes expressed as program information 105. The program information 105 has the same structure as that of the illegitimate-program information 400 of FIG. 1.

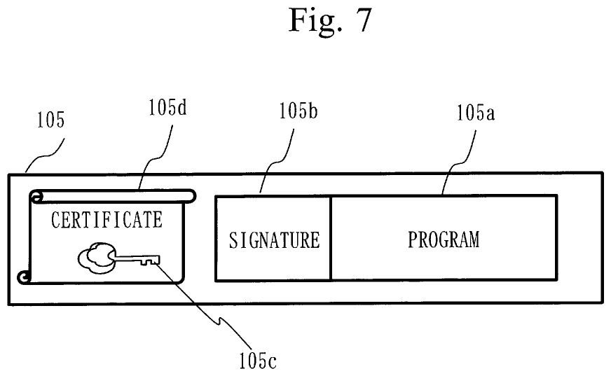

FIG. 7 is a diagram illustrating the program information 105. As illustrated in FIG. 7, the program information 105 includes the following (a), (b), and (c).

(a) a program 105a

(b) a signature 105b

(c) a certificate 105d including a public key 105c

Description will be made with referring to FIG. 6. CMS will be described below as an example. The program information extraction unit 13 determines whether the content 104b has been formatted by CMS. For example, with CMS, the content 104b is encoded by ASN.1. The program information extraction unit 13 checks whether the content 104b is decodable by ASN.1.

If the content 104b is decodable by ASN.1, then in step S301 and step S302, the program information extraction unit 13 checks whether signed data, which is signed-data attached with object identifier=1. 2. 840. 113549. 1. 7. 2, is included in the decoded content 104b.

If the signed data is included, in step S303, the program information extraction unit 13 extracts the signed data as the program information 105. If not included, the program information extraction unit 13 ends the process.

<Behavior of Certificate Extraction Unit 14>

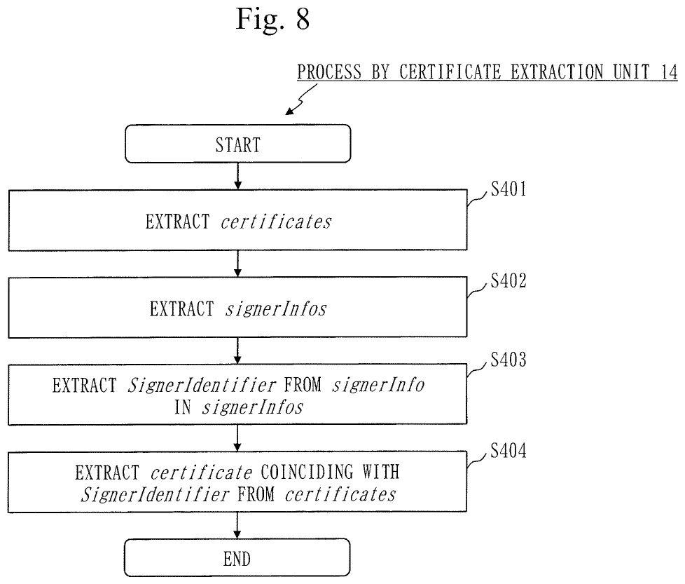

FIG. 8 is a flowchart indicating a process of extracting the certificate 105d, being a code signature certificate, from the program information 105 by the certificate extraction unit 14. The process by the certificate extraction unit 14 will be described with referring to FIG. 8.

The certificate extraction unit 14 extracts the certificate 105d from the program information 105 as the code signature certificate. The signed-data which is the program information 105 includes certificates as signer data for verifying the signature.

In step S401, the certificate extraction unit 14 extracts certificates from the program information 105.

In step S402, the certificate extraction unit 14 extracts signerInfos, being information on the signer, from the program information 105.

In step S403, the certificate extraction unit 14 extracts SignerIdentifier from signerInfo in signerInfors.

Note that SignerIdentifier is information that identifies a certificate used for signature.

In step S404, the certificate extraction unit 14 extracts certificate coinciding with SignerIdentifier from certificates. The certificate extraction unit 14 outputs extracted certificate to the certificate attribute extraction unit 15 as the certificate 105d being a code signature certificate used for signature.

<Behavior of Certificate Attribute Extraction Unit 15>

Behavior of the certificate attribute extraction unit 15 will be described with referring to FIG. 2. The certificate attribute extraction unit 15 extracts a certificate attribute including Subject or SubjectAltName, being an attribute indicating the owner of the certificate 105d, from the certificate 105d. The certificate attribute is the owner information 107 indicating the owner of the certificate 105d. As indicated by step S102 of FIG. 4, the certificate attribute extraction unit 15 extracts the certificate attribute. The code signature certificate generally has X.509 format, as described in Non-Patent Literature 1. Since X.509 format is a standard format, it allows extraction of the certificate attribute. The certificate attribute extraction unit 15 outputs the owner information 107 being the certificate attribute to the search unit 16.

<Behavior of Search Unit 16>

The search unit 16 searches the domain information search service 6 with using the owner information 107 as a search key, so as to acquire a management domain name managed by the owner indicated by the owner information 107 from the domain information search service 6. This will be specifically described below.

As indicated by step S103 of FIG. 4, the search unit 16 transmits the owner information 107 to the domain information search service 6 via the communication interface 303 using the owner information 107 as the search keyword. The domain information search service 6 is a web server device. Specifically, the domain information search service 6 is a domain information search program that runs on a web server. Subject extracted as the owner information 107 includes information, called CommonName, which corresponds to the name of a holder of the certificate. Other than this, Subject includes an attribute, such as Organaization and OrganaizationUnit, which corresponds to a name of an organization or department the holder of the certificate belongs to. A name of a company is sometimes included in CommonName as in a case of, for example, “CommonName=Example Systems, Incorporated”.

<Behavior of Domain Information Search Service 6>

The domain information search service 6 receives the owner information 107 as the search keyword and searches a domain managed by the owner information 107. Although the owner of the domain may be managed under various names such as a subscriber's name and an administrator's name in the domain information search service 6, in the present case, the domain information search service 6 refers to the administrator's name. Consequently, information searched for by the domain information search service 6 is used as the management domain name 202.

As the management domain name 202, for example, one or more names such as the following (1) to (4) are searched for.

(1) example 123456789.com

(2) www1.example 123456789.com

(3) www2.example 123456789.com

(4) abcdefghijklmn.co.jp

These management domain names 202 are used by both of the website and the email address. There is an organization that manages domain names seemingly unrelated to each other. In the above case, (1) to (3) are not seemingly related to (4) if judging only from the domain names. In fact, however, (1) to (3) and (4) are managed by the same organization. This occurs when the organization is an enterprise that operates a plurality of companies and develops varied businesses. The domain information search service 6 transmits each management domain name 202 to the search unit 16 as a search result.

When the search unit 16 receives the management domain name 202 from the domain information search service 6, the search unit 16 outputs the management domain name 202 to the determination unit 18.

<Behavior of Determination Unit 18>

The determination unit 18 collates the management domain name 202 acquired by the search unit 16 with the domain name 108 which is a download domain name extracted by the first extraction unit 92, and determines whether or not the program included in the reception data 103 is illegitimate based on a collation result. This will be specifically described below.

The determination unit 18 takes as input the management domain name 202 and the domain name 108. As indicated by step S104 and step S105 of FIG. 4, the determination unit 18 checks whether the management domain name 202 includes a domain name 108. If the checking result indicates that the management domain name 202 includes a domain name 108, the determination unit 18 determines that a legitimate program is obtained, as indicated by step S106 of FIG. 4. If the management domain name 202 does not include a domain name 108, the determination unit 18 determines that an illegitimate program is obtained, as indicated by step S106a of FIG. 4. This is because the program is obtained from a domain other than a domain managed by the owner of the certificate.

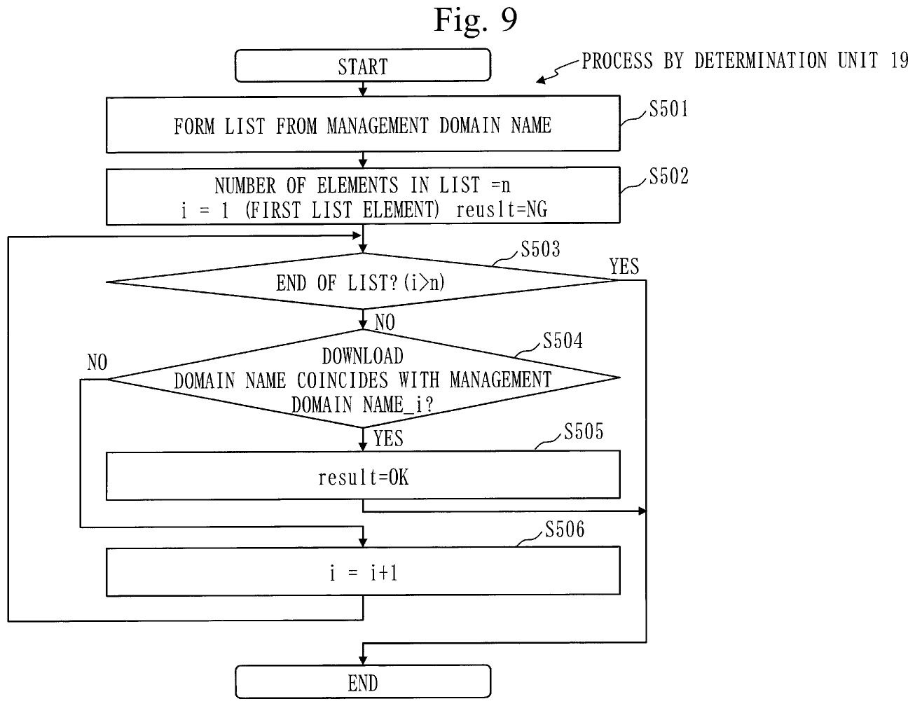

FIG. 9 is a flowchart indicating a process of checking a domain name by the determination unit 18. The process by the determination unit 18 will be described in detail with referring to FIG. 9.

In step S501, the determination unit 18 transforms the management domain name 202 into a list. The list contains one or more management domain names 202.

The number of elements on the list will be expressed by n, and the first list element will be set to i=1.

Each element of the list will be expressed by management domain name_i (i=1 to n).

In step S502, the determination unit 18 assigns NG to a variable number result.

In step S503, the determination unit 18 checks whether an end of the list is reached. If no in step S503, the process proceeds to step S504.

In step S504, the determination unit 18 checks whether the domain name 108 coincides with management domain name_i.

If the domain name 108 coincides with management domain name_i (yes in step S504), then in step S505, the determination unit 18 assigns OK to the variable result, and the process ends.

If the domain name 108 does not coincide with the management domain name_i (no in step S504), the process proceeds to step S506; i is incremented by one, and the process proceeds to step S503.

According to the flowchart of FIG. 9, if the management domain name 202 includes a domain name 108, then result=OK, and the process ends. If the management domain name 202 does not include a domain name 108, then result=NG, and the process ends. Note that result=OK indicates that the determination unit 18 determines the program as legitimate. Note that result=NG indicates that the determination unit 18 determines the program as illegitimate.

If the illegitimate-program information 400 has been created based on a code signature key and a certificate which are stolen by an attacker, the illegitimate-program information 400 is distributed from a domain name managed by the attacker via a website or an email with an attachment. Hence, when the domain name managed by the attacker is extracted as the domain name 108, the domain name 108 is not included in the management domain name 202 acquired from the domain information search service 6. This indicates that the file 401 being a program is illegitimate.

The determination unit 18 outputs the determination result indicating authenticity or illegitimacy to the output unit 19 as a determination result 109. The determination result 109 may include the following information (1) to (4).

(1) a determination result indicating authenticity or illegitimacy

(2) a domain name 108

(3) owner information 107

(4) program information 105

When analyzing the data, the analysis unit 12 may extract a download time stamp if the data is downloaded from a website, and a reception time stamp if the data is an attachment to an email. The analysis unit 12 supplies as input an extracted time stamp 111 to the determination unit 18. The determination unit 18 may include the inputted time stamp 111 into the determination result 109. By forming the determination result 109 in the above manner, it is possible to recognize what program information 105 obtained when and where is illegitimate based on the time stamp 111 and the domain name 108.

<Behavior of Output Unit 19>

The output unit 19 edits the determination result 109 into an output format and outputs the edited determination result 109 to the input/output interface 305 as a determination result 110. The output format is, for example, a text file. The output unit 19 may be provided with a display processing unit 19a having a function of displaying on a display device so that a user of the verification device 1 can visually observe the determination result 110.

***Effect of Embodiment 1***

Regarding the program information 105 obtained by downloading from a website or obtained as an attachment attached to an email, the verification device 1 according to Embodiment 1 examines the domain name managed by the owner of a corresponding certificate based on the owner information in the certificate. The verification device 1 then verifies whether the program information 105 is obtained from the domain name. With this verification, it is possible to detect whether the program information 105 being a code-signed program has been created based on a stolen code signature key and a stolen certificate.

<Modification>

According to Embodiment 1, the function of the verification device 1 is implemented by software. As a modification, the function of the verification device 1 may be implemented by hardware.

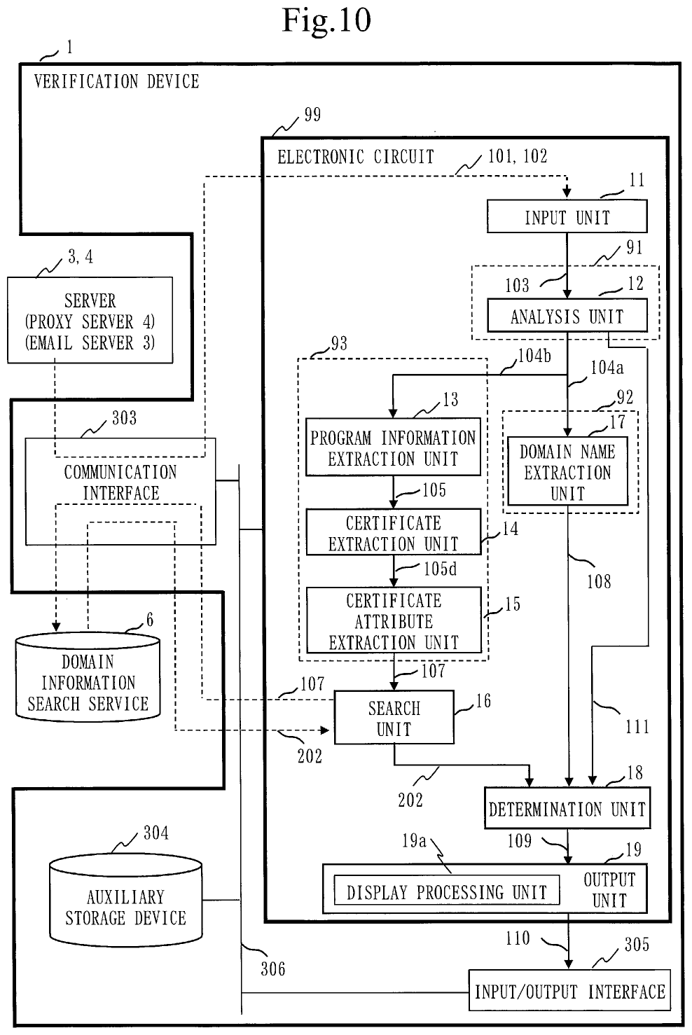

FIG. 10 is a diagram illustrating a configuration of a verification device 1 according to a modification of Embodiment 1. The verification device 1 is provided with an electronic circuit 99, an auxiliary storage device 304, a communication interface 303, and an input/output interface 305. The electronic circuit 99 is a dedicated electronic circuit to implement functions of an input unit 11, an analysis unit 12, a program information extraction unit 13, a certificate extraction unit 14, a certificate attribute extraction unit 15, a search unit 16, a domain name extraction unit 17, a determination unit 18, and an output unit 19. The electronic circuit 99 is specifically a single circuit, a composite circuit, a programmed processor, a parallel-programmed processor, a logic IC, a GA, an ASIC, or an FPGA. Note that GA is an acronym of Gate Array; ASIC, Application Specific Integrated Circuit; and FPGA, Field-Programmable Gate Array. The functions of constituent elements of the verification device 1 may be implemented by a single electronic circuit or by a plurality of electronic circuits through dispersion. According to another modification, some of the functions of the constituent elements of the verification device 1 may be implemented by an electronic circuit, and the remaining functions may be implemented by software.

Both the processor and the electronic circuit are also referred to as processing circuitry. That is, in the verification device 1, the functions of the input unit 11, analysis unit 12, program information extraction unit 13, certificate extraction unit 14, certificate attribute extraction unit 15, search unit 16, domain name extraction unit 17, determination unit 18, and output unit 19 are implemented by the processing circuitry.

In the verification device 1, “unit” in each of the input unit 11, the analysis unit 12, the program information extraction unit 13, the certificate extraction unit 14, the certificate attribute extraction unit 15, the search unit 16, the domain name extraction unit 17, the determination unit 18, and the output unit 19 may be replaced by “stage”. Also, behavior by the input unit 11, analysis unit 12, program information extraction unit 13, certificate extraction unit 14, certificate attribute extraction unit 15, search unit 16, domain name extraction unit 17, determination unit 18, and output unit 19 of the verification device 1 can be comprehended as a verification method.

### Embodiment 2

A verification device 1 according to Embodiment 2 will be described below.

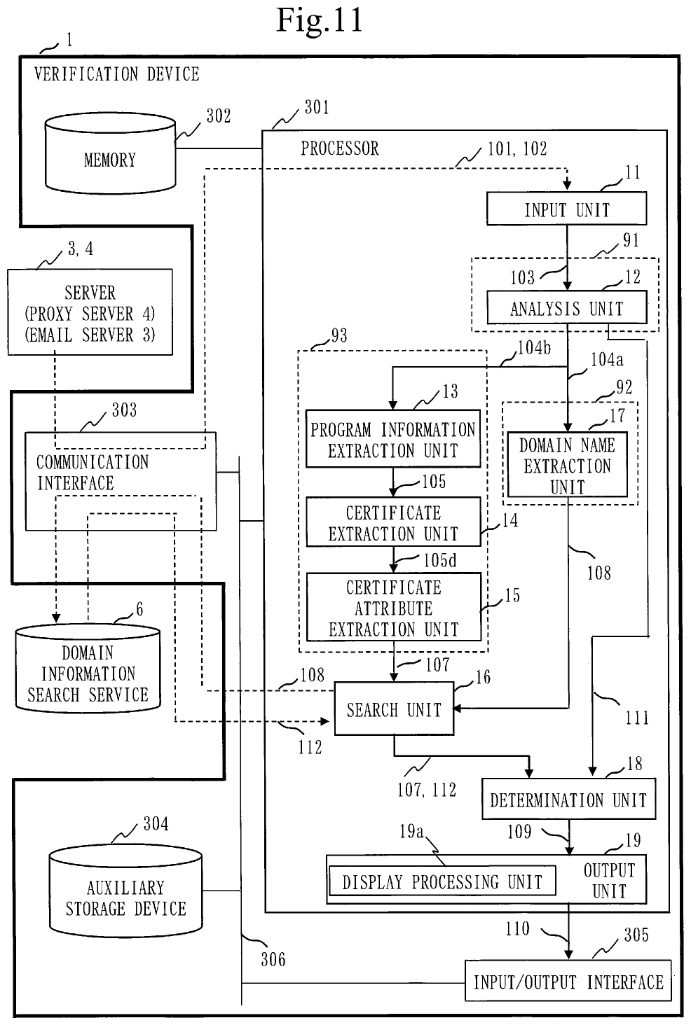

FIG. 11 is a functional configuration diagram of the verification device 1 according to Embodiment 2. The verification device 1 of Embodiment 2 is different from that of Embodiment 1 in the following respects. Apart from that, processes of the individual units are the same as those of Embodiment 1.

(1) A domain name extraction unit 17 outputs a domain name 108 to a search unit 16.

(2) The search unit 16 acquires an administrator's name 112 associated with the domain name 108 in a domain information search service 6 from the domain information search service 6 by searching the domain information search service 6 using the domain name 108 extracted by a first extraction unit 92 as a search key.

That is, the search unit 16 searches the domain information search service 6 using the domain name 108 as a search keyword for the domain information search service 6. As information to be searched for, the search unit 16 searches for the administrator's name 112 of the domain indicated by the domain name 108, with the domain information search service 6. The search unit 16 outputs the administrator's name 112 for the domain name 108, which is a result of search on the domain information search service 6, and owner information 107 extracted by a certificate attribute extraction unit 15, to a determination unit 18.

(3) The determination unit 18 collates the administrator's name 112 acquired by the search unit 16 with the owner information 107 extracted by a second extraction unit 93, and determines whether or not a program included in reception data 103 is illegitimate based on a collation result.

That is, if the administrator's name 112 for the domain name 108 coincides with the owner indicated by the owner information 107, the determination unit 18 determines that a program 105a of the program information 105 is authentic; if not, illegitimate.

***Behavior of Determination Unit 18***

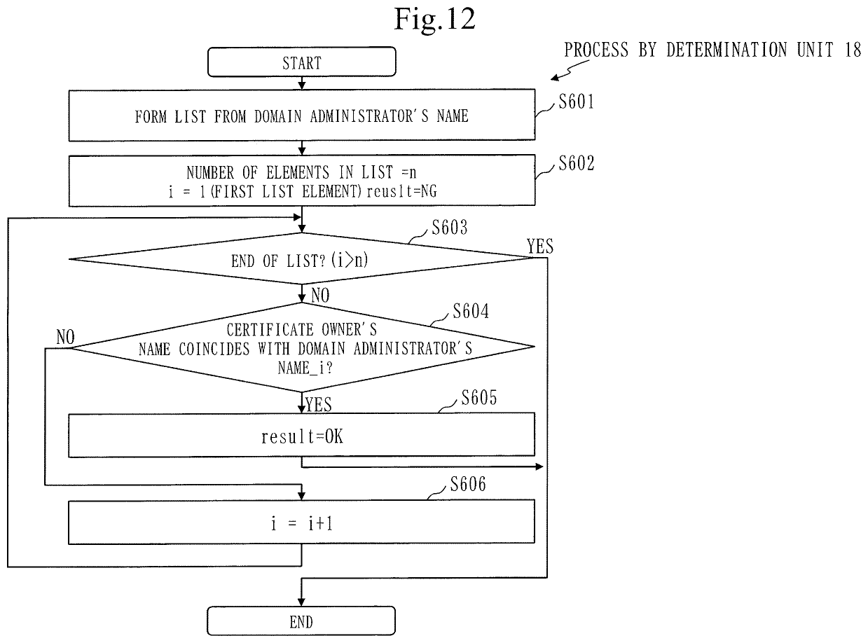

FIG. 12 is a flowchart indicating a process of checking the owner of the certificate by the determination unit 18. There is a possibility that a different name of the administrator's name 112 is also searched for. Therefore, the determination unit 18 carries out the process as indicated in FIG. 12.

In step S601, the determination unit 18 transforms the domain administrator's name 112 into a list. One or more administrator's names 112 are described on the list. The determination unit 18 then expresses the number of elements on the list by n and sets the first list element to i=1. The determination unit 18 expresses each element of the list by domain administrator name_i (i=1 to n).

In step S602, the determination unit 18 assigns NG to a variable number result.

In step S603, the determination unit 18 checks whether an end of the list is reached. If no, the process proceeds to step S604.

In step S604, the determination unit 18 checks whether the certificate owner's name indicated by the owner information coincides with domain administrator's name_i. If the certificate owner's name coincides with domain administrator's name_i, then in step S605, the determination unit 18 assigns OK to the result and ends the process. If the certificate owner's name does not coincide with domain administrator's name_i, the process proceeds to step S606; i is incremented by one and the process proceeds to step S603.

According to the flowchart, if the domain administrator's name 112 includes an owner indicated by the owner information 107, then result=OK, and the process ends. If the domain administrator's name 112 does not include an owner indicated by the owner information 107, then result=NG, and the process ends. Note that result=OK is a determination that the program is legitimate, and that result=NG is a determination that the program is illegitimate.

***Effect of Embodiment 2***

Regarding the program information 105 which is a code-signed program, the verification device 1 verifies whether the owner of the certificate owner coincides with the administrator of the domain name 108. With this verification, it is possible to detect whether the program information 105 being a code-signed program has been created based on a stolen code signature key and a stolen certificate.

### Embodiment 3

In Embodiments 1 and 2, it is assumed that one signature is attached to the program information 105 which is a code-signed program. However, taking an example of SignersInfos of CMS, if SignerInfo can be plural, there is a case where a plurality of signatures for the program are included in the program information 105 which is a code-signed program. Note that CMS is merely an example of the format, and that a code-signed program having a plurality of signatures is possible. For example, a case is possible where a developer X and a developer Y individually attach their signatures to a program. A case is also possible where a developer Z employs two types of signature algorithms and attaches two signatures generated by the two types of signature algorithms to a program. Embodiment 3 is an embodiment that includes a process on program information 105 which is a code-signed program attached with a plurality of signatures.

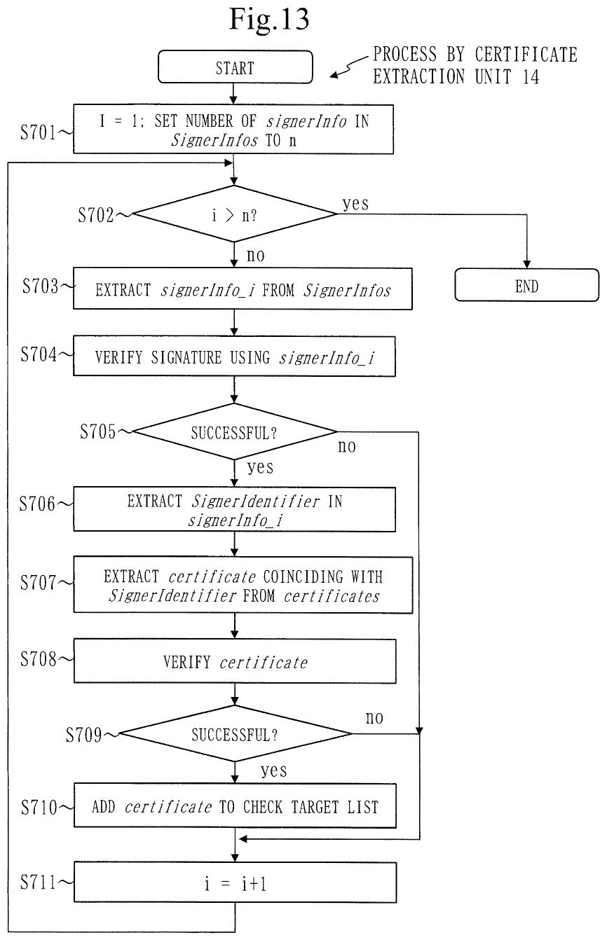

FIG. 13 indicates a process of a certificate extraction unit 14 in Embodiment 3. FIG. 13 corresponds to FIG. 8. The following process indicates a process of CMS.

In step S701, the certificate extraction unit 14 sets i=1 and expresses the number of signerInfo in SignerInfos by n.

In step S702, the certificate extraction unit 14 checks whether i>n. If yes, the process ends. If no, the process proceeds to step S703.

In step S703, the certificate extraction unit 14 extracts signerInfo_i, being signerInfo, from SingerInfos.

In step S704, the certificate extraction unit 14 verifies the signature using signerInfo_i.

As a signature verification method, a method performed using CMS has been specified, which is employed here.

In step S705, the certificate extraction unit 14 checks whether signature verification is successful. If yes, the process proceeds to step S706. If no, the process proceeds to step S711.

In step S706, the certificate extraction unit 14 extracts SignerIdentifier in signerInfo_i. The extraction method is the same as that of step S403 of FIG. 8.

In step S707, the certificate extraction unit 14 extracts certificate coinciding with SignerIdentifier from certificate. The extraction method is the same as that of step S404 of FIG. 8.

In step S708, the certificate extraction unit 14 verifies certificate. As a method of verifying certificate, an existing method in CMS or general PKI (Public Key Infrastructure) is available, which is employed here.

In step S709, the certificate extraction unit 14 checks whether verification of certificate is successful. If yes, the process proceeds to step S710. If no, the process proceeds to step S711.

In step S710, the certificate extraction unit 14 adds certificate to a check target list.

In step S711, the certificate extraction unit 14 sets i=i+1.

The check target list is empty in step S701. After the process of FIG. 13 is completed, the certificate extraction unit 14 updates certificate recorded on the check target list to certificate_j (j=1 to k). That is, k of certificate are recorded on the check target list. Then, after the certificate extraction unit 14, a certificate attribute extraction unit 15 and a search unit 16 of FIG. 2 execute a process for each certificate_j. As a result, a management domain name 202 of each certificate_j=1 to k) becomes obvious. Furthermore, a determination unit 18 checks each management domain name. When determination result 109=authentic is obtained for 1 or more management domain names, the determination unit 18 judges that the code-signed program is legitimate.

If the check target list is empty, a code signature certificate which is a corresponding certificate is not available for any signature. Hence, the determination unit 18 judges that the code-signed program is illegitimate.

***Effect of Embodiment 3***

In the above case, as described, a plurality of signatures are attached to a code-signed program obtained by downloading from a website or obtained as an attachment to an email. Even in this case, the verification device 1 can examine, based on information on an owner in each corresponding certificate, a domain name managed by the owner, and can examine whether the code-signed program is obtained from this domain name. Hence, it is possible to detect whether the code-signed program is created based on a stolen code signature and a stolen certificate.

### Embodiment 4

In Embodiment 3, a case is assumed where a plurality of code signature certificates correspond to a plurality of signatures. When determination result 109=authentic is obtained for 1 or more code signature certificates, the determination unit 18 of the verification device 1 judges that the code-signed program is legitimate. As compared to this, in Embodiment 4, a threshold value may be set for a number with which determination result 109=authentic is obtained, and the judgment may be made with using the threshold value. For example, assume that there are p of code signature certificates. When determination result 109=authentic is obtained for q % or more of the p of code signature certificates, the verification device 1 judges that the code-signed program is legitimate. Alternatively, the verification device 1 may judge that a code-signed program is legitimate when determination result 109=authentic is obtained for r or more of code signature certificates where r is equal to or less than a number of code-signed signatures. Alternatively, the verification device 1 may judge that the code-signed program is legitimate when determination result 109=authentic is obtained for all of the p of code signature certificates.

***Effect of Embodiment 4***

In the above case, as described, a plurality of signatures are attached to a code-signed program obtained by downloading from a website or obtained as an attachment to an email. Even in this case, the verification device 1 examines, based on information on an owner in each corresponding certificate, a domain name managed by the owner. The verification device 1 then examines whether the code-signed program is obtained from this domain name. When a number of times of coincidences between them is less than a predetermined threshold value, the verification device 1 can detect that the code-signed program is created based on a stolen code signature and a stolen certificate.

Having described Embodiments 1 to 4 above, two or more of the embodiments may be practiced by combination. Alternatively, of these embodiments, one may be practiced partly. Alternatively, of these embodiments, two or more may be partly combined and practiced. The present invention is not limited to these embodiments, and various changes may be made as necessary.

### REFERENCE SIGNS LIST

1: verification device; 2: attacker; 3: email server; 4: proxy server; 5: terminal; 6: domain information search service; 7: user; 11: input unit; 12: analysis unit; 13: program information extraction unit; 14: certificate extraction unit; 15: certificate attribute extraction unit; 16: search unit; 17: domain name extraction unit; 18: determination unit; 19: output unit; 19a: display processing unit; 101: data from proxy server 4; 102: data from email server 3; 103: reception data; 104a: header; 104b: content; 105: program information; 105a: program; 105b: signature; 105c: public key; 105d: certificate; 107: owner information; 108: domain name; 109: determination result; 110: determination result; 111: time stamp; 112: administrator's name; 202: management domain name; 301: processor; 302: memory; 303: communication interface; 304: auxiliary storage device; 305: input/output interface; 306: signal line; 400: illegitimate-program information; 401: file; 402: signature; 403: certificate; 403a: public key; 91: acquisition unit; 92: first extraction unit; 93: second extraction unit; 99: electronic circuit.

1-9. (canceled)

10. A verification device comprising:
processing circuitry
to acquire reception data including a public key certificate, a program, and a digital signature, the public key certificate including a public key, the digital signature being attached to the program,
to extract, from the reception data, a download domain name indicating a domain name of a sender of the reception data,
to extract, from the public key certificate included in the reception data, owner information indicating an owner of the public key certificate,
to acquire a management domain name managed by the owner indicated by the owner information from a domain information search service by searching the domain information search service using the owner information as a search key, and
to collate the acquired management domain name with the extracted download domain name and to determine whether or not the program included in the reception data is illegitimate based on a collation result.

11. The verification device according to claim 10,
wherein the processing circuitry
acquires an administrator's name associated with the download domain name in the domain information search service from the domain information search service by searching the domain information search service using the extracted download domain name as a search key, and
collates the acquired administrator's name with the extracted owner information, and determines whether or not the program included in reception data is illegitimate based on a collation result.

12. The verification device according to claim 10, wherein the reception data is downloaded from a website.

13. The verification device according to claim 11, wherein the reception data is downloaded from a website.

14. The verification device according to claim 10, wherein the reception data is transmitted by an email.

15. The verification device according to claim 11, wherein the reception data is transmitted by an email.

16. A verification device comprising:
processing circuitry
to acquire reception data including a public key certificate, a program, and a digital signature, the public key certificate including a public key, the digital signature being attached to the program,
to extract, from the reception data, a download domain name indicating a domain name of a sender of the reception data,
to extract, from the public key certificate included in the reception data, owner information indicating an owner of the public key certificate,
to acquire an administrator's name associated with the download domain name in a domain information search service from the domain information search service by searching the domain information search service using the extracted download domain name as a search key, and
to collate the acquired administrator's name with the extracted owner information and to determine whether or not the program included in reception data is illegitimate based on a collation result.

17. A non-transitory computer-readable medium storing a verification program to cause a computer to execute:
a process of acquiring reception data including a public key certificate, a program, and a digital signature, the public key certificate including a public key, the digital signature being attached to the program;
a process of extracting, from the reception data, a download domain name indicating a domain name of a sender of the reception data;
a process of extracting, from the public key certificate included in the reception data, owner information indicating an owner of the public key certificate;
a process of acquiring a management domain name managed by the owner indicated by the owner information from a domain information search service by searching the domain information search service using the owner information as a search key; and
a process of collating the acquired management domain name with the extracted download domain name and determining whether or not the program included in the reception data is illegitimate based on a collation result.

18. A non-transitory computer-readable medium storing a verification program to cause a computer to execute:
a process of acquiring reception data including a public key certificate, a program, and a digital signature, the public key certificate including a public key, the digital signature being attached to the program;
a process of extracting, from the reception data, a download domain name indicating a domain name of a sender of the reception data;
a process of extracting, from the public key certificate included in the reception data, owner information indicating an owner of the public key certificate;
a process of acquiring an administrator's name associated with the download domain name in a domain information search service from the domain information search service by searching the domain information search service using the extracted download domain name as a search key; and
a process of collating the acquired administrator's name with the extracted owner information and determining whether or not the program included in reception data is illegitimate based on a collation result.

19. A verification method comprising:
acquiring reception data including a public key certificate, a program, and a digital signature, the public key certificate including a public key, the digital signature being attached to the program;
extracting, from the reception data, a download domain name indicating a domain name of a sender of the reception data;
extracting, from the public key certificate included in the reception data, owner information indicating an owner of the public key certificate;
acquiring a management domain name managed by the owner indicated by the owner information from a domain information search service by searching the domain information search service using the owner information as a search key; and
collating the acquired management domain name with the extracted download domain name and determining whether or not the program included in the reception data is illegitimate based on a collation result.

20. A verification method comprising:
acquiring reception data including a public key certificate, a program, and a digital signature, the public key certificate including a public key, the digital signature being attached to the program;
extracting, from the reception data, a download domain name indicating a domain name of a sender of the reception data;
extracting, from the public key certificate included in the reception data, owner information indicating an owner of the public key certificate;
acquiring an administrator's name associated with the download domain name in a domain information search service from the domain information search service by searching the domain information search service using the extracted download domain name as a search key; and
collating the acquired administrator's name with the extracted owner information and determining whether or not the program included in reception data is illegitimate based on a collation result.
